(19) United States
(12) Patent Application Publication
(10) Pub. No.: US 2018/0184684 A1
(43) Pub. Date: Jul. 5, 2018

(54) VEGETABLE PROTEIN-BASED FROZEN CONFECTION

(71) Applicant: Conopco, Inc., d/b/a UNILEVER, Englewood Cliffs, NJ (US)

(72) Inventors: Andrew Richard COX, Glen Rock, NJ (US); Jennifer Elizabeth FREEMAN, Rushden (GB); Damiano ROSSETTI, Ketttering (GB); Jeffrey UNDERDOWN, Wellingborough (GB)

(73) Assignee: Conopco, Inc., d/b/a UNILEVER, Englewood Cliffs, NJ (US)

(21) Appl. No.: 15/738,448

(22) PCT Filed: Jun. 22, 2016
(86) PCT No.: PCT/EP2016/064470

§ 371 Date: Dec. 20, 2017

Related U.S. Application Data
(60) Provisional application No. 62/186,817, filed on Jun. 30, 2015.

(51) Int. Cl. A23G 9/38; A23G 9/32

(52) U.S. Cl. CPC A23G 9/38; A23V 2002/00; A23G 9/327

(57) ABSTRACT

A frozen confection which contains low amounts of protein and which minimizes ingredients of animal origin, such as milk ingredients. The confection provides the sensory experience of ice cream. The experience is reflected in texture, mouth feel and melt profile. The compositions of the invention include a triglyceride oil, a vegetable protein, and optionally sugar solids, an 1.5 wt % or less protein, wherein the total protein comprises between 25 and 100% protein from vegetable sources, 10-40 wt % sugar solids, 0-1 wt % emulsifier and 0-1 wt % stabilizer. The pH of the composition is at least 5. In an alternative invention, the protein composition may also comprise at least 25 wt % of the total protein from dairy sources.

### FIELD OF THE INVENTION

### Background of the Invention

Although many consumers appreciate frozen confections such as ice cream, some desire to have a choice of frozen confections with somewhat different ingredients. In particular, there are some consumers who would like the option of frozen ingredients with fewer or no milk-based ingredients such as milk fat, milk protein and milk sugar.

Frozen confections or other food products wherein part or all of dairy ingredients have been replaced have been described in the patent literature, including Cox, et al. EP 1967077, Medina et al. WO2014/008580, Tergesen US Patent Application Publication No. US2014/0255591, Boursier et al. US Patent Application Publication No. US2011/0305740, Perks et al. WO2009/023560, Eisner et al. US Patent Application Publication No. US2008/0089990, CN103859129, Samoto et al. US Patent Application Publication No. US2014/0113866, Bilet US 2012/0121775, Colavito US 2011/0206808. Colavito WO 2013/019771, Carella et al. US 2014/0271993, Crank WO 2007/103753, Sabbagh et al. WO 2010/033985, CN 103349148, Jarrett WO 2006/096377, Eisner et al. US 2009/0011107, Back et al. US 2006/0127560, Tsujii et al. US 20070128323, CN102028089, WO 2009/063458, JP2006158391, Tabuteau et al. GB 2194877, JP11276086, Snowden et al. US 2007/0154611, CN1685920, Crank et al. WO 97/37547, Leusner et al. U.S. Pat. No. 4,696,826, and WO 86/02809.

Frozen confections or other food products wherein part or all of dairy ingredients have been replaced have been described in the non-patent technical literature as well, including Slind-Flop, “A new scoop for chef Leruth,” Restaurant Business (1986), Volume 85, Number 8, pp. 154-155, Simmons et al., “Cottonseed and soya protein ingredients in soft-serve frozen desserts,” Journal of Food Science, 1980, 45 (6), 1505-8, Lawhon, et al. Utilization of membrane-produced oilseed isolates in soft serve frozen desserts, Journal of the American Oil Chemists' Society, 1980, 57 (9), 302-6, Lightowler, et al., The Vegan Dairy, Nutrition and Food Science, 1998, (May-June), (3), 153-157, Ahanian, “Production of Ice Cream by Using Soy Milk, Stevia and Isomalt,” Advances in Environmental Biology (2014), 8(11S5), 9-16 , Bisla, et al. “Development of ice-creams from soybean milk & watermelon seeds milk and evaluation of their acceptability and nourishing potential,” Advances in Applied Science Research (2012), 3(1), 371-376, and Iguttia, et al. “Substitution of ingredients by green coconut (Cocos nucifera L) pulp in ice cream formulation,” Procedia Food Science (2011), 1, 1610-1617.

Other literature includes Pereira, et al., “Influence of the partial substitution of skim milk powder for soy extract on ice cream structure and quality,” European Food Research and Technology (2011), 232(6), 1093-1102, Anon, “ADM offers soy as dairy protein alternative,” Decision News Media, 2007, (November 14), Kebary et al, “Quality of ice cream as influenced by substituting non-fat dry milk with whey-bean proteins coprecipitates,” Egyptian Journal of Dairy Science (1997), Volume 25, Number 2, pp.311-325, Anon, “Indulgent ice-cream,” Dairy Foods, 1994, 95 (6), 86, LaBell , “Multi-use milk substitute,” Food Processing, USA (1991), Volume 52, Number 11, pp. 118-120 , Gupta, et al., “Fabricated dairy products,” Indian Dairyman (1987), Volume 39, Number 5, pp. 199-208, Regan, “Ben & Jerry Are Going to Make Non-Diary Ice Cream Flavors,” Time Magazine (Jun. 16, 2015), P1, and Hannigan, “Corn/soy-based frozen desserts: taste and nutrition made to order,” Food Engineering (1982), Volume 54, Number 3, 92 p.

Several nut-based frozen desserts are on the market in the United States, including So-Delicious Almond Milk Frozen Dessert (ingredients include almond milk (water, almonds), organic dried cane syrup, coconut oil, vanilla extract, natural flavor, gum arabic, carob bean gum, sea salt) and Almond Dream Non-Dairy Frozen Dessert (ingredients include filtered water, evaporated cane juice, almonds, expeller pressed oil (sunflower and/or safflower and/or canola), tapioca maltodextrin, natural vanilla extract, potato starch, guar gum, carob bean gum, carrageenan, soy lecithin, sea salt, natural flavors).

Despite the many disclosures of frozen confections in which milk ingredients are fully or partly replaced, there is still a need for a frozen confection which successfully imitates ice cream. For some, it is especially preferred that the use of expensive ingredients such as proteins can be reduced, so that the “off taste” that comes from the non-dairy component is minimized or eliminated.

### SUMMARY OF THE INVENTION

The invention relates to a frozen confection which is very low in protein and which need not include any ingredients of animal origin, such as milk ingredients. Notwithstanding the low protein and minimized or absent animal-derived ingredients, the product provides the sensory experience of ice cream. The experience is reflected in texture, mouth feel and melt profile. Fine microstructure is preferred.

The compositions of the invention include a triglyceride oil, such as coconut oil, a vegetable protein, and optionally animal protein. The product may also include an emulsifier and/or a stabilizer. The invention also relates to a process for making the product, as described herein. More specifically, the base frozen confection of the invention comprises 2-8 wt % triglyceride oil, 1.5 wt % or less protein wherein between 25 and 100% wt % protein comes from vegetable sources, 10-40 wt % sugar solids, 0-1 wt % emulsifier and 0-1 wt % stabilizer. The vegetable protein is pea protein, chickpea beans, soy protein, cotton seed protein, sunflower seed, lupin protein, oat protein, lentil protein, sesame seed protein, canola protein, broad bean protein, horse bean protein, alfalfa protein, clover protein, rice, tapioca, potato, carob protein and/or corn protein.

Ingredients from animal sources, such as milk, are not required for compositions of the invention; the compositions may be essentially free of milk proteins and other ingredients from animal sources such as dairy. Thus, the products of the invention will have special appeal to consumers who need to minimize protein intake or animal protein intake, who have milk allergies or intolerances, who prefer not to eat animal-based products, who are concerned about the levels of cholesterol and saturated fat in milk, and who prefer products made from more sustainable ingredients. In addition, the plant-based ingredients used in the present compositions tend to be easier to obtain and less expensive than milk ingredients.

For those who wish to avoid soy, the products of the invention may be essentially free of soy ingredients, as well.

Thus, the present invention provides a frozen confection which minimizes dairy ingredients, particularly dairy protein, while also minimizing off-tasting vegetable components. This is achieved with the base frozen confection of the invention, which comprises 2-8 wt % triglyceride oil, such as a saturated vegetable oil like coconut oil or palm oil, 1.5 wt % or less total protein wherein between 25 and 100% wt % protein comes from one or more of the vegetable sources listed below, and optionally 0-75 wt % comes from milk protein, 10-40 wt % sugar solids, 0-1 wt % emulsifier and 0-1 wt % stabilizer. The vegetable protein is pea protein, chickpea beans, soy protein, cotton seed protein, sunflower seed, lupin protein, oat protein, lentil protein, sesame seed protein, canola protein, broad bean protein, horse bean protein, alfalfa protein, clover protein, rice protein, tapioca protein, potato protein, carob protein and/or corn protein. The base frozen confection especially includes from 0.3 to 1.5 wt % total protein, preferably from 0.5 to 1 wt % total protein, most preferably from 0.5 to 0.8 wt % total protein. The optional dairy protein can come from one or more of skim milk powder, sodium caseinate, or whey protein , whole milk, skim milk, condensed milk, evaporated milk, cream, butter, butterfat, whey, milk solids non-fat, etc

For a more complete of the above and other features and advantages of the invention, reference should be made to the following description of the preferred embodiment.

### BRIEF DESCRIPTION OF THE DRAWINGS

FIG. 1 is a scanning electron micrograph of the 2.5% pea protein ice cream of Example 1.

FIG. 2 is a scanning electron micrograph of the 2.5% soy protein ice cream of Example 1.

FIG. 3 is a scanning electron micrograph of the 1% pea protein ice cream of Example 1.

FIG. 4 are scanning electron micrographs of the 1% soy protein ice cream of Example 1.

FIG. 5 is a scanning electron micrograph of the 1% lupin protein ice cream of Example 1.

FIG. 6 are scanning electron micrographs of the 0.75% pea protein/0.25% milk protein ice cream of Example 1.

### DETAILED DESCRIPTION OF THE INVENTION

As used in this application, “vegetable” refers to plant material that is not a fruit, a seed or a nut. Therefore, as used herein, “vegetable protein” does not include protein derived from nuts. As used in this application, “nuts” refer to a seed which comes from within a hard shell. Although technically categorized as a legume, for the purpose of this application, peanuts shall be considered a nut rather than a legume/vegetable. Nuts shall not be considered to be a “vegetable” in the present application.

The frozen confection is a frozen product such as ice cream, sherbet, water ice and the like. “Frozen,” as used herein, denotes that the product is solidified under freezing conditions to a hardpack or pumpable consistency which is not fluid or semi-fluid. The ice content of the frozen confection should be between 30 and 65% ice, and more preferably between 40% and 60% ice when measured at −18° C. The frozen confection is preferably a water-continuous emulsion. The term “ice cream” is used herein to denote a frozen confection which is similar to ice cream even if it would not meet the requirements for such, e.g., level of milk fat, in all jurisdictions.

By “base frozen confection” is meant the frozen confection but not including ingredients which will exist non-homogeneously in the confection, e.g., inclusions, such as visibly identifiable viscous flavorings like fudge and caramel swirls, nut pieces, cookie dough pieces, fruit pieces, baked pieces, candies, etc. The finished product is from 70% to 100% mix or base frozen confection, depending on the level of flavorings or inclusions. Inclusions (again, not part of the frozen matrix formed by the mix) range from 0% to 30 wt %, preferably from 0.5 to 30 wt %, especially from 10 to 30 wt %, of the frozen confection. Flavorings may be in the range of 0.01 to 20% wt of the frozen confection.

The pH of the frozen confections of the invention which simulate ice cream are typically 5 or above, especially 5.5-8.5, more preferably 5.5-8. Frozen confections simulating fruit products such as sherbet may have a lower pH, e.g., 3-7. Sherbets may include fruit juice or puree at a level of from 0.5 to 5 wt %, a food acid (typically citric acid) up to a level of 1%, especially from 0.1 to 1% and fat up to a level of 1%, especially 0.1 to 1%.

The frozen confection of the invention is preferably aerated, i.e., it has an overrun of more than 10% and preferably less than 250%. More preferably, the overrun is between 30 and 200% overrun, and most preferably between 50 and 150% overrun. Overrun: The extent of aeration of a product is measured in terms of “overrun”, which is defined as:

$$\% Overrun = \frac{weight of mix - weight of aerated product}{weight of aerated product} \times 100$$

where the weights refer to a fixed volume of mix or product. Overrun is measured at atmospheric pressure.

The source of proteins can be any vegetable source providing they function to help the creation of a good ice cream microstructure. The base frozen confections of the invention include 1.5 wt % or less total protein, especially from 0.3 to 1.5 wt % total protein, preferably from 0.5 to 1 wt % total protein, most preferably from 0.5 to 0.8 wt % total protein.

Between 25 and 100 wt % of the total protein in the base frozen confection, i.e., the mix, is from one or more vegetable sources and especially between 50 and 100 wt % of the total protein is from vegetable sources. Types of vegetable protein which may be used herein include the following and combinations thereof: pea protein, chickpea beans, soy protein, cotton seed protein, sunflower seed, lupin protein, oat protein, lentil protein, sesame seed protein, canola protein, broad bean protein, horse bean protein, alfalfa protein, clover protein, rice protein, tapioca protein, potato protein, carob protein and corn protein, especially soy, pea, lupin and/or oat. Pea protein is especially preferred.

Preferably, the vegetable proteins of the invention are not fermented. Although some canola protein may be used preferably less than 5 wt % of the total protein in the base frozen confection is canola protein. Most preferably the base frozen confection is essentially free of canola protein.

The non dairy protein can be mixed with a dairy protein component, e.g. skim milk powder, sodium caseinate, or whey protein , whole milk, skim milk, condensed milk, evaporated milk, cream, butter, butterfat, whey, milk solids non-fat, etc. In terms of the total protein content, preferably the maximum amount of protein which is dairy protein is 50%, and more preferably 25% of the total protein. That is, the amount of dairy protein ranges from 0-75 wt % of the total protein in the base frozen confection, preferably from 0-50 wt % if the total protein, and especially from 0 wt % to 25 wt % of the total protein in the base frozen confection. Dairy protein may be absent, or present at low levels of, say 0.1 wt % or higher within the above ranges.

In terms of the microstructure, the protein should enable the creation of a fine microstructure where the average bubble diameter is between 20 and 200 um, preferably between 20 and 150 um and most preferably between 20 and 100 um in the produced ice cream product after hardening to below −18° C.

The vegetable protein is preferably added in the form of a powder, agglomerate or paste. Preferably the powder, agglomerate or paste, or other form in which the vegetable protein is added, is essentially free of starch hydrolyzate.

The base frozen confection will generally be essentially free of protein hydrolyzates.

If it is desired to include a milk sugar, lactose may be present in the base frozen confections used in the invention within the range of from 0 to 5 wt %, especially from 0.5 to 2.5 wt %.

The base frozen confection includes from 1-8% fats, especially saturated oils, most preferably saturated vegetable oils. Preferred levels of fats are from 2 to 6 wt %, especially 3 to 5 wt %. By saturated oils is meant oils and fats having at least 30wt % of their fatty acid moieties as saturated fatty acids. Typical fats or oils that are used to make frozen confections include butter oil, coconut oil, palm oil, and mixtures thereof. Saturated vegetable oils include, but are not limited to coconut, cocoa butter, illipe, shea, palm, palm kernel, and sal and mixtures thereof. Coconut oil and other vegetable oils are preferred. In some cases it may be desirable that the base frozen confection be essentially free of oils from animal origin such as butter oil.

While saturated vegetable oils are preferred, butter fat from cream and other dairy sources may be used if the product is not to be dairy free.

If it is desired to include vegetable oils and fats other than saturated oils, these may include, for instance, soybean oil, corn oil, peanut oil, safflower oil, flaxseed oil, cottonseed oil, rapeseed oil, canola oil, olive oil, sunflower oil, high oleic sunflower oil, and mixtures thereof. Total vegetable oil preferably constitutes from 60 to 100 wt % of the triglyceride fat in the base frozen confection, i.e. up to 40% of the triglyceride fat may come from a non-vegetable source, e.g. dairy.

The oil is dispersed in the ice cream mix in the form of an oil in water emulsion. The size of the emulsion droplets can be determined by light scattering. Preferably the median diameter D (0, 5) in the ice cream mix prior to freezing is between 0.2 and 1.2 μm, more preferably between 0.2 and 1 μm, and most preferably between 0.2 and 0.8 μm.

If desired, the product may include an emulsifying agent. These induce the formation of de-stabilized fat in the freezing process. Typical emulsifiers used include mono-di-glycerides of saturated fatty acids, mono-di-glycerides of partially unsaturated fatty acids, tween, egg yolk, fractions of egg yolk, and lecithin. Preferably, the emulsifier used is a combination of saturated and unsaturated fatty acids of mono-di-glycerides. The total concentration of emulsifier in the base frozen confection is preferably between 0.05 and 1%, more preferably between 0.1 and 0.5%. The product may be essentially free of emulsifying agents.

Stabilizers and/or thickeners are typically used to slow the melting rate of ice cream to provide resistance to structural change on storage, and improve mouth feel on consumption. Typical stabilisers used include: locust bean gum, tara gum, carrageenan, guar gum, sodium alginate, pectins, xanthan gum, gelatin, microcrystalline cellulose, citrus fibers and mixtures thereof. The total concentration of stabilizer is preferably 0-1 wt %, especially 0.1-1 wt %, more preferably 0.02-0.6 wt %, especially between 0.05 and 0.6%, most preferably between 0.1 and 0.4% based on the base frozen confection.

Generally the compositions of the invention will be naturally sweetened. The composition of the invention comprises one or more sugar compounds selected from monosaccharides, disaccharides and oligosaccharides. Sugars control the amount of ice in the product and impact the sweetness of the ice cream or other frozen confection. Typical sugars include: sucrose, fructose, glucose, maltose, galactose, dextrose, corn syrups, maltodextrin, and lactose. Preferably the total concentration of sugar solids in the product is between 15 and 40%, and more preferably between 20 and 35%, especially 28-34 wt %, most preferably 30-34 wt %, based on the weight of the base frozen confection.

The composition may contain sugar alcohols, alone or in combination with one or more sugar compounds selected from monosaccharides, disaccharides, and oligosaccharides. Preferably, though, the maximum concentration of sugar alcohols is maximally 10% by weight of the base frozen confection, more preferred maximally 8% by weight of the base frozen confection. More preferably, the maximum concentration of sugar alcohols is 6% by weight. If used, sugar alcohols may be present at 0.5 wt % and above, more preferably 1 wt % and above. Alternatively and preferably sugar alcohols are absent from the composition. If present, the preferred sugar alcohols are erythritol, sorbitol, maltitol, lactitol, glycerol, and xylitol, and more preferred maltitol and erythritol. The composition may also contain soluble fibres like inulin and/or polydextrose and/or oligofructosaccharides in addition to or to replace part of the oligosaccharides.

Natural low- or non-caloric sweeteners such as stevia may be used at levels of from 0.01 to 0.15 wt %, especially 0.01 to 0.05 wt % of the base frozen confection. However, it is more preferred that the compositions of the invention are free of intense sweeteners (e.g., 10× or more sweetness than sucrose, especially 100× or more sweetness than sucrose) such as artificial sweeteners and stevia.

If it is desired to use artificial sweeteners, any of the artificial sweeteners well known in the art may be used, such as aspartame, saccharine, Alitame (obtainable from Pfizer), acesulfame K (obtainable from Hoechst), cyclamates, neotame, sucralose and the like, and mixtures thereof. The sweeteners are used in varying amounts of about 0.005% to 1% of the base frozen confection, preferably 0.007 wt % to 0.73 wt % depending on the sweetener, for example. Aspartame may be used at a level of 0.01 wt % to 0.15 wt % of the base frozen confection, preferably at a level of 0.01 wt % to 0.05 wt %. Acesulfame K is preferred at a level of 0.01 wt % to 0.15 wt % of the base frozen confection.

If desired, the product may include polydextrose. Polydextrose functions both as a bulking agent and as a fiber source and, if included, may be present at from 1 to 10 wt %, especially from 3 to 6 wt % of the base frozen confection.

Polydextrose may be obtained under the brand name Litesse from Danisco Sweeteners. Among other fiber sources which may be included in the compositions of the invention are fructose oligosaccharides such as inulin. Additional bulking agents which may be used include maltodextrin, sugar alcohols, corn syrup solids, sugars or starches. Total bulking agent levels in the base frozen confections of the invention, excluding any sugars or corn syrup solids or sugar alcohols, which are included with sweeteners above, may be from about 5 to 20 wt %, preferably 13 to 16 wt %. If desired, Sugar alcohols such as glycerol, sorbitol, lactitol, maltitol, mannitol, etc. may also be used to control ice formation. However, the present invention also contemplates formulations in which glycerol is excluded.

Flavorings may be included in the frozen confection of the invention, preferably in amounts that will impart a mild, pleasant flavor. The flavoring may be any of the commercial flavors employed in ice cream, such as varying types of cocoa, pure vanilla or artificial flavor, such as vanillin, ethyl vanillin, chocolate, extracts, spices and the like. It will further be appreciated that many flavor variations may be obtained by combinations of the basic flavors. The confection compositions are flavored to taste. Suitable flavorants may also include seasoning, such as salt, and imitation fruit or chocolate flavors either singly or in any suitable combination.

Malt powder can be used, e.g., to impart flavor, preferably at levels of from 0.01 to 3.0 wt % of the base frozen confection, especially from 0.05 to 1 wt %.

Preservatives such as potassium sorbate may be used as desired.

Adjuncts such as wafers, variegates, e.g., viscous, free oil-containing flavorings and sauces/coatings may be included as desired. Some of these may be in the form of inclusions such as viscous flavorings like fudge and caramel, nut pieces, cookie dough pieces, fruit pieces, dark and/or milk chocolate chunks, etc.

Water/moisture/ice will generally constitute the balance of the base frozen confection at, e.g., from 40-90 wt %, especially from 50-75 wt %.

Preferably, triglyceride vegetable oils/fats used in the present invention are not partially hydrogenated. Fat which has been hydrogenated to an extent such that there are still more than 2 wt % of unsaturated fatty acid moieties in the fat are considered partially hydrogenated herein. Even fully hydrogenated fats (fats hydrogenated so that there are 2 wt % or fewer unsaturated fatty acid moieties in the fat) are not preferred but may be used as ingredients in the composition in certain cases. The compositions of the invention preferably are essentially free, more preferably completely free, of hydrogenated triglyceride fats. Hydrogenation of fats refers to the process wherein fats are chemically reacted by human intervention with hydrogen to replace one or more double bonds with hydrogen atoms.

All percentages herein are by weight unless otherwise stated or clearly required by context. Unless otherwise stated or clearly required by context, percentages are by weight of the base frozen confection.

By “essentially free” herein it is mean that the indicated ingredient is present at a level of 0.1 wt % or less of the base frozen confection.

Processes used for the manufacture of the product are similar to those used for conventional frozen confections. Typical process steps include: ingredient blending, pumping, pasteurization, homogenization, cooking, aeration, packaging and freezing.

Products can be manufactured by batch or by continuous processes, preferably continuous. Ingredients may be either liquid or dry, or a combination of both. Liquid ingredients can be blended by the use of positive metering pumps to a mixing tank or by in-line blending. Dry ingredients must be hydrated during the blending operations. This is most commonly accomplished by the use of turbine mixers in processing vats or by incorporating the dry material through a high speed, centrifugal pump. The blending temperature depends upon the nature of the ingredients, but it must be above the melting point of any fat and sufficient to fully hydrate proteins and any gums used as stabilizers.

Pasteurization is generally carried out in high temperature short time (HTST) units, in which the homogenizer is integrated into the pasteurization system. Protein is advisedly fully hydrated before adding other components which might interfere with the hydration.

### EXAMPLE 1: Ice Cream Prepared with a Range of Non Dairy Proteins

Here we describe a range of ice cream produced using a protein source as either: pure non dairy protein; or a mix of non-dairy with dairy protein.

### Materials and Formulations:

Coconut oil: refined ex Cargill.

Skimmed milk powder, ex Dairy crest (Esher, Surrey, UK). Protein content 35%.

Soy protein, Supro 120, ex Solae. Protein content 90%.

Pea protein, Nutralys S85F, ex Roquette. Protein content 80%.

Lupin protein Isolate, ex. Prolupin. Protein content 90%.

Dextrose monohydrate: C-Pharm Dex 02010 ex Cargill.

Sucrose, ex Tate and Lyle (London, UK).

Glucose syrup 28DE: spray dried C-Dry GL 01924, ex Cargill.

Glucose-Fructose Syrup, 63DE, 78% Dry matter (LF9), ex Cargill.

HP60: Mono-di-glycerides of saturated fatty acids: Grindsted Mono-Di- Glycerides HP60, ex

DuPont Danisco. Made from edible, fully hydrogenated palm oil. Manufacturers

specifications: Total monoglyceride 50-63%; iodine value 3.

PS222: Mono-di-glycerides of partially saturated fatty acids: Grindsted Mono-Di-Glycerides PS222, ex

DuPont Danisco. Made from edible, refined palm based fats and/or fully hardened palm based fat. Manufacturers specifications: Total monoglyceride 64-88%; iodine value <30.

Locust Bean Gum (LBG), LBG246 (GAX-00008), ex DuPont

Guar gum: Grindsted Guar 250, ex DuPont Danisco.

Carrageenan L100: kappa-carrageenan Genulacta L100, ex CP Kelco.

The full formulations for all the ice creams prepared in Example 1 are summarised in Table 1.

### Production of Ice Cream

### (i) 5 Preparation of the Mix

The pre-mix is the unhomogenised, unpasteurised mixture of ingredients. 50 kg of pre-mix from each of the formulations of Table 1 was made up by adding the stabiliser and emulsifiers to hot water (80C), followed by the sugars, protein, and oil. The pre-mix was then heated to 82 ° C. with a plate heat exchanger, followed by homogenisation with a two stage valve homogeniser (APV Crepaco Homogeniser F-8831 3DDL) at 275 bar pressure and 25 bar back pressure. The pre-mix was then pasteurised at this temperature for 25 seconds. The mix was cooled to 5° C. with a plate heat exchanger, and then collected in 50 kg churns. Flavour was added and the churns stored in a chill room at 2° C. until further processing.

Homogenisation pressure influences the final emulsion droplet size. Homogenisation pressure is preferably in the range 100 to 500 bar, more preferably between 150 and 350 bar, and most preferably 200 and 325 bar. Typically a back pressure of around 10% homogenisation pressure is used.

### (ii) Preparation of Frozen Ice Cream

The mixes were aerated and frozen to form ice cream using an APV M75. All aerated products were produced at 100% overrun with a mix throughput of approximately 40 L hr⁻¹. The extrusion temperature was between −5 and −6° C. Products were collected in 500 ml waxed paper cartons and hardened in a blast freezer at −35° C. for 2 hours before storage at −25° C.

TABLE 1
Formulations for all ice creams produced in Example 1. Values quoted for ingredient
concentrations are in weight %.

| | | | pea | pea | | | |
|---|---|---|---|---|---|---|---|
| | | | 0.75% + | 0.5% + | | | |
| | pea | pea | smp | smp | soy | soy | lupin |
| | 2.5% | 1.0% | 0.25% | 0.5% | 2.5% | 1.0% | 1% |
| WATER | 59.753 | 60.628 | 60.168 | 59.783 | 60.128 | 60.768 | 60.778 |
| F&O Coconut oil | 5.0 | 5.0 | 5.0 | 5.0 | 5.0 | 5.0 | 5.0 |
| Locust Bean Gum (LBG) | 0.15 | 0.15 | 0.15 | 0.15 | 0.15 | 0.15 | 0.15 |
| Guar Gum | 0.15 | 0.15 | 0.15 | 0.15 | 0.15 | 0.15 | 0.15 |
| Carrageenan Kappa Rich E407 | 0.015 | 0.015 | 0.015 | 0.015 | 0.015 | 0.015 | 0.015 |
| Sucrose | 12.80 | 12.80 | 12.80 | 12.80 | 12.80 | 12.80 | 12.80 |
| Glucose syrup DE28, dry KH | 7.0 | 8.0 | 8.0 | 8.0 | 7.0 | 8.0 | 8.0 |
| Glucose-Fructose Syrup, 63DE, 78DM | | | | | | | |
| (LF9) | 8.30 | 8.30 | 8.30 | 8.30 | 8.30 | 8.30 | 8.30 |
| dextrose monohydrate | 3.11 | 3.11 | 3.11 | 3.11 | 3.11 | 3.11 | 3.11 |
| HP60 Mono Sat. Palm Kosher Halal | 0.15 | 0.15 | 0.15 | 0.15 | 0.15 | 0.15 | 0.15 |
| PS222 Mono Part. Sat. Palm Kosher Halal | 0.15 | 0.15 | 0.15 | 0.15 | 0.15 | 0.15 | 0.15 |
| Bourbon vanilla | 0.075 | 0.075 | 0.075 | 0.075 | 0.075 | 0.075 | 0.075 |
| Flavour Vanilla | 0.222 | 0.222 | 0.222 | 0.222 | 0.222 | 0.222 | 0.222 |
| Non Dairy Protein | 3.125 | 1.250 | 0.940 | 0.625 | 2.750 | 1.110 | 1.100 |
| Skim Milk Powder (SMP) | | | 0.770 | 1.470 | | | |
| Total | 100.00 | 100.00 | 100.00 | 100.00 | 100.00 | 100.00 | 100.00 |
| D[3,2] MIX—in sds-urea [0 m] or * water | 0.211* | 0.270 | 0.322 | 0.341 | 0.243* | — | 0.368 |
| D[0,5] MIX—sds-urea [0 m] or * water | 0.286* | 0.366 | 0.492 | 0.651 | 0.338* | — | 0.471 |

### Methods of Analysis

(i) Fat Droplet Sizing in Ice Cream Mixes and the Ice cream

The mix samples were prepared in a solution of Sodium dodecyl sulphate (SDS) (Sigma UK) and urea (Sigma UK) (6.6M urea, 0.1 SDS) and then analyzed using a Malvern Mastersizer 2000. The SDS/urea solution ensures that any weakly bound or flocculated fat droplets are separated into individual fat droplets. 2 ml of chilled mix were added to 20 ml solution of SDS/urea, mixed and left for 10 minutes. The samples were added drop-wise into the Mastersizer 2000 for analysis. The samples were characterised by the surface weighted diameter, D(3,2), which is a measure of the mean fat droplet size, and D(0,5) the median diameter. Fat droplets were sized in the melted ice cream using the same method described above.

### (ii) Scanning Electron Microscopy (SEM) of Ice Cream Products

The samples were cooled to −80° C. on dry ice and a sample section cut. This section, approximately 5 mm×5 mm×10 mm in size, was mounted on a sample holder using a Tissue Tek: OCT™ compound (PVA 11, Carbowax 5 and 85 non-reactive components). The sample including the holder was plunged into liquid nitrogen slush and transferred to a low temperature preparation chamber Oxford Instrument CT1500HF. The chamber was under vacuum, approximately 10-4 bar, and the sample was warmed up to −90° C. Ice was slowly etched to reveal surface details not caused by the ice itself, at this temperature under constant vacuum for 60 to 90 seconds. Once etched, the sample was cooled to −110° C. ending the sublimation, and coated with gold using argon plasma. This process also took place under vacuum with an applied pressure of 10⁻¹ millibars and current of 4 milliamps for 45 seconds. The sample was then transferred to a conventional Scanning Electron Microscope (JSM 5600), fitted with an Oxford Instruments cold stage at a temperature of −160° C. The sample was examined and areas of interest captured via digital image acquisition software.

### Methods to Measure Bubble Size

The air bubble size in the ice cream is extracted using imagine analysis tools.

The gas bubble size (diameter) distribution as used herein is defined as the size distribution obtained from the two dimensional representation of the three dimensional microstructure, as visualized in the SEM micrograph, determined using the following methodology.

Samples are imaged at 3 different magnifications (for reasons explained below), and the bubble size distribution of a sample is obtained from this set of micrographs in three steps:
1. Identification and sizing of the individual gas bubbles in the micrographs
2. Extraction of the size information from each micrograph
3. Combination of the data from the micrographs into a single size distribution

All of these steps, other than the initial identification of the gas bubbles, can conveniently be performed automatically on a computer, for example by using software such as MATLAB R2006a (MathWorks, Inc) software.

### Identification and Sizing of the Individual Gas Bubbles in the Micrographs

Firstly, a trained operator (i.e. one familiar with the microstructures of aerated systems) traces the outlines of the gas bubbles in the digital SEM images using a graphical user interface. The trained operator is able to distinguish gas bubbles from ice crystals (which are present in frozen aerated products and are the same order of magnitude in size) because the gas bubbles are approximately spherical objects of varying brightness/darkness whereas ice crystals are irregular-shaped objects of a uniform grey appearance.

Secondly, the size is calculated from the selected outline by measuring the maximum area as seen in the two dimensional cross-sectional view of the micrograph (A) as defined by the operator and multiplying this by a scaling factor defined by the microscope magnification. The bubble diameter is defined as the equivalent circular diameter d:

d=2\sqrt{A/π}

This is an exact definition of the diameter of the two-dimensional cross-section through a perfect sphere. Since most of the gas bubbles are approximately spherical, this is a good measure of the size.

Extraction of the Size Information from Each Micrograph

Gas bubbles which touch the border of a micrograph are only partially visible. Since it is not therefore possible to determine their area, they must be excluded. However, in doing so, systematic errors are introduced: (i) the number of gas bubbles per unit area is underestimated; and (ii) large gas bubbles are rejected relatively more often since they are more likely to touch the border, thus skewing the size distribution. To avoid these errors, a guard frame is introduced (as described in John C. Russ, “The Image Processing Handbook”, second edition, CRC Press, 1995). The guard frame concept uses a virtual border to define an inner zone inside the micrograph. The inner zone forms the measurement area from which unbiased size information is obtained, as illustrated in the Figure below (a schematic depiction of a micrograph, in which gas bubbles that touch the outer border of the micrograph have been drawn in full, even though in reality only the part falling within the actual micrograph would be observed.)

Bubbles are classified into 5 classes depending on their size and position in the micrograph. Bubbles that fall fully within the inner zone (labelled class 1) are included. Bubbles that touch the border of the virtual micrograph (class 2) are also included (since it is only a virtual border, there is fact full knowledge of these bubbles). Bubbles that touch the actual micrograph border (class 3) and/or fall within the outer zone (class 4) are excluded. The exclusion of the class 3 bubbles introduces a bias, but this is compensated for by including the bubbles in class 2, resulting in an unbiased estimate of the size distribution. Very large bubbles, i.e. those larger than the width of the outer zone (class 5), can straddle both the virtual (inner) border and the actual outer border and must therefore be excluded, again introducing bias. However, this bias only exists for bubbles that are wider than the outer zone, so it can be avoided by excluding all bubbles of at least this size (regardless of whether or not they cross the actual border). This effectively sets an upper limit to the gas bubble size that can be reliably measured in a particular micrograph. The width of the inner zone is chosen to be 10% of the vertical height of the micrograph as a trade-off between the largest bubble that can be sized (at the resolution of the particular micrograph) and the image area that is effectively thrown away (the outer zone).

There is also minimum size limit (at the resolution of the micrograph) below which the operator cannot reliably trace round gas bubbles. Therefore bubbles that are smaller than a diameter of 20 pixels are also ignored.

Combination of the Data from the Micrographs into a Single Size Distribution

As explained above, it is necessary to introduce maximum and minimum cut-off bubbles sizes. In order that these minimum and maximum sizes are sufficiently small and large respectively so as not to exclude a significant number of bubbles, some samples may need to be imaged at 3 different magnifications: e.g. 100×, 300× and 1000×. This occurs if there is a wide distribution in bubble sizes, and the skilled user can determine what magnifications are appropriate in order to capture the full size distribution: one magnification or more. As an example for the case of 3 different magnifications, each magnification yields size information in a different range, given below:

| Magnification | Minimum bubble size | Maximum bubble size |
|---|---|---|
| 100x | 20 μm | 83 μm |
| 300x | 6.6 μm | 28 μm |
| 1000x | 2.0 μm | 8.3 μm |

Thus bubbles as small as 2 μm and as large as 83 μm are counted. Visual inspection of the micrographs at high and low magnifications respectively confirmed that essentially all of the bubbles fell within this size range. The magnifications are chosen so that there is overlap between the size ranges of the different magnifications (e.g. gas bubbles with a size of 20-28 μm are covered by both the 100× and 300× micrographs) to ensure that there are no gaps between the size ranges. In order to obtain robust data, at least 500 bubbles are sized; this can typically be achieved by analysing one micrograph at 100×, one or two at ×300 and two to four at ×1000 for each sample.

The size information from the micrographs at different magnifications is finally combined into a single size distribution histogram. Bubbles with a diameter between 20 μm and 28 μm are obtained from both the 100× and 300× micrographs, whereas the bubbles with a diameter greater than 28 μm are extracted only from the 100× micrographs. Double counting of bubbles in the overlapping size ranges is avoided by taking account of the total area that was used to obtain the size information in each of the size ranges (which depends on the magnification), i.e. it is the number of bubbles of a certain size per unit area that is counted. This is expressed mathematically, using the following parameters:

N=total number of gas cells obtained in the micrographs

dₖ=the k^{th} outlined gas cell with k∈[1, N]

Aᵢ=the area of the inner zone in the i^{th} micrograph

Rᵢ=the range of diameters covered by the i^{th} micrograph (e.g. [20 μm, 83 μm]) B(j) =the j^{th} bin covering the diameter range: [jW, (j+1)W)

The total area, S(d), used to count gas bubbles with diameter d is given by adding the areas of the inner zones (Aᵢ) in the micrographs for which d is within their size range (Rᵢ).

$$S ( d ) = {\sum }_{i \vert d ∈ {R}_{i}} {A}_{i}$$

The final size distribution is obtained by constructing a histogram consisting of bins of width W μm. B(j) is the number of bubbles per unit area in the j^{th} bin (i.e. in the diameter range j×W to (j+1)×W). B(j) is obtained by adding up all the individual contributions of the gas bubbles with a diameter in the diameter range j×W to (j+1)×W, with the appropriate weight, i.e. 1/S(d).

$$B ( j ) = {\sum }_{k ∈ D} 1 / S ( {d}_{k} )$$

where

Dⱼ={k|dₖ∈[jW,(j+1)W)}

Magnifications used are chosen by the skilled user in order to extract bubble size through the analysis software.

The bubble size distributions are conveniently described in terms of the normalised cumulative frequency, i.e. the total number of bubbles with diameter up to a given size, expressed as a percentage of the total number of bubbles measured.

Alternative expressions of bubble size distribution can also be used, e.g. D(3,2) (surface weighted mean), or D(1,0) the number mean.

For the present invention, we refer to either ranges of bubble size diameters or the D(3,2) surface weighted mean.

### RESULTS

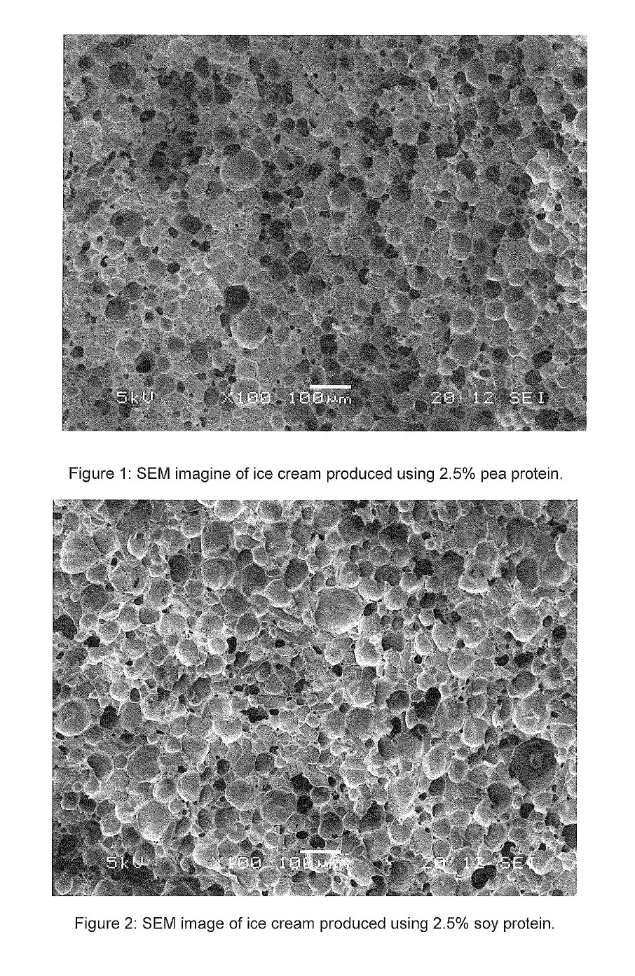

Ice creams produced using 2.5% pea and 2.5% soy protein exhibited good microstructures as shown in FIGS. 1 and 2, respectively. For both of these cases, the ice crystal and air bubble diameters are typically less than 100 um. These sizes are as in the range one would expect for an ice cream with good texture using typical concentrations of protein >2%

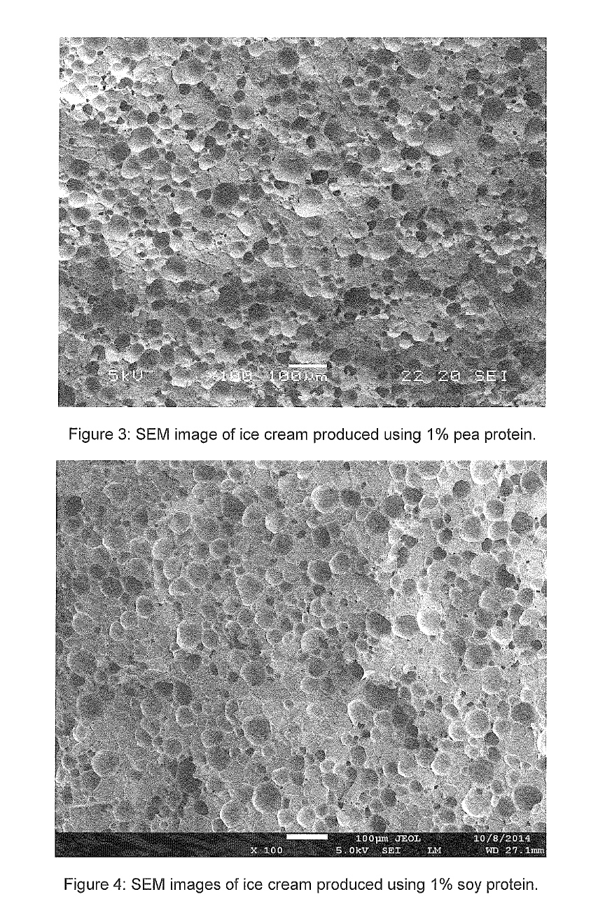

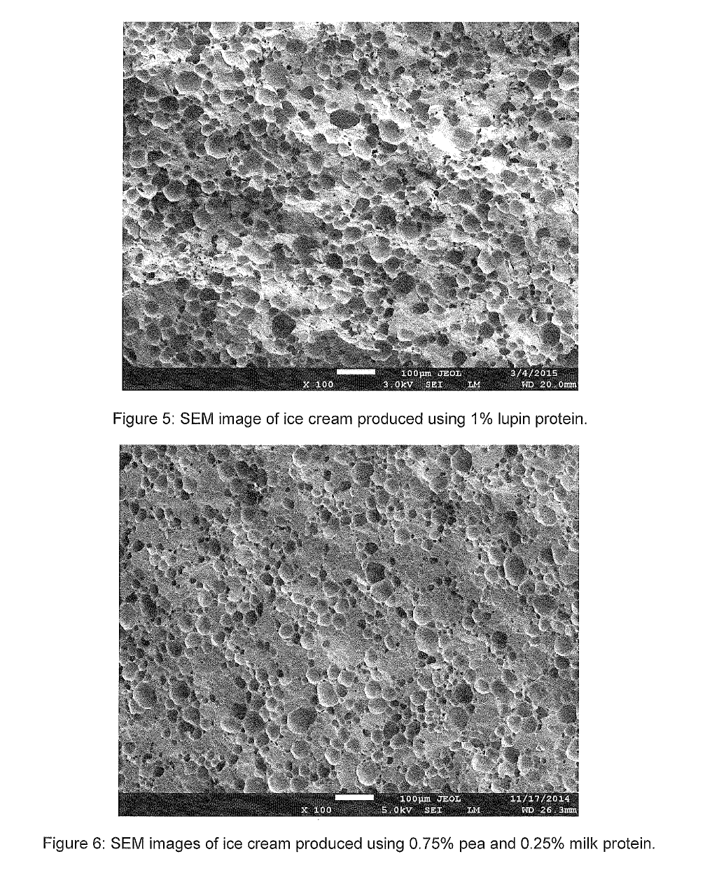

In FIG. 3-6, it can be seen that surprisingly the 1% pea, 1% soy, 1% lupin protein and 0.75 pea/0.25 milk protein products had acceptable structure similar to that seen for the higher protein 2.5% pea and soy protein products in FIGS. 1 and 2, respectively. Specifically, as to structures of ice cream produced using 1% pea, 1% soy, 1% lupin, and 0.75% pea/0.25% milk protein shown in FIGS. 3 and 6, respectively, for all of these examples using 1% protein, the ice crystal and air bubble diameters are typically less than 100 um. Therefore, we would expect these ice creams to have a good texture.

As can be seen for all products in Example 1, the emulsion droplet size D[0, 5] for the mix reflects good structure. Notably, mixes exhibiting a D[0,5] of greater than 0.2 and less than 1.19 μm, especially less than 1.16, show a good microstructure.

### EXAMPLE 2: Ice Cream Produced Using Oat Protein

| | | | | | 15% Oat |
|---|---|---|---|---|---|
| | | | | 1% Oat | protein, |
| | | 1% Pea | 1% Oat | protein, | 7% fat, |
| | 1% Oat | and Oat | Protein, | Stabiliser | sugars |
| Ingredients | Protein | protein | 7% Fat | free | adjusted |
| Water | 60.027 | 60.457 | 58.027 | 60.342 | 60.027 |
| Coconut Oil | 5 | 5 | 7 | 5 | 7 |
| HP60 | 0.15 | 0.15 | 0.15 | 0.15 | 0.15 |
| PS222 | 0.15 | 0.15 | 0.15 | 0.15 | 0.15 |
| Sucrose | 13 | 13 | 13 | 13 | 13 |
| Dextrose | 3 | 3 | 3 | 3 | 3 |
| 28DE | 7 | 7 | 7 | 7 | 6 |
| MD40 | 9 | 9 | 9 | 9 | 8 |
| Carrageenan | 0.015 | 0.015 | 0.015 | 0 | 0.015 |
| Kappa | | | | | |
| Guar | 0.15 | 0.15 | 0.15 | 0 | 0.15 |
| LBG | 0.15 | 0.15 | 0.15 | 0 | 0.15 |
| Proatein (oat | 2.16 | 1.08 | 2.16 | 2.16 | 2.16 |
| protein | | | | | |
| concentrate) | | | | | |
| Nutralys pea | | 0.65 | | | |
| protein | | | | | |
| vanilla flavour | 0.148 | 0.148 | 0.148 | 0.148 | 0.148 |
| vanilla flavour | 0.05 | 0.05 | 0.05 | 0.05 | 0.05 |
| | 100 | 100 | 100 | 100 | 100 |
| Homogenisation | 300 bar + | 301 bar + | 302 bar + | 303 bar + | 304 bar + |
| pressure | 30 | 30 | 30 | 30 | 30 |

It should be understood of course that the specific forms of the invention herein illustrated and described are intended to be representative only, as certain changes may be made therein without departing from the clear teaching of the disclosure. Accordingly, reference should be made to the appended claims in determining the full scope.

1-35. (canceled)

36. A frozen confection comprising:
From 2 to 8 wt % of a saturated oil from the group of coconut, illipe, shea, palm, palm kernel, and sal and mixtures thereof, and
1.5 wt % or less of total protein, wherein between 25 and 100% protein of the total protein is from one or more vegetable sources selected from the group of pea protein, chickpea beans, cotton seed protein, sunflower seed, lentil protein, sesame seed protein, canola protein, broad bean protein, horse bean protein, alfalfa protein, clover protein, rice protein, tapioca protein, potato protein, carob protein and/or corn protein, the pH of the composition being at least 5, the frozen confection being essentially free of hydrogenated triglyceride fats and essentially free of soy ingredients,

37. The frozen confection of claim 36 further comprising from between 2 and 5% triglyceride fat.

38. The frozen confection of claim 36 comprising less than 1.5 wt % protein.

39. The frozen confection of claim 36 comprising less than 1 wt % total protein.

40. The frozen confection of claim 36 essentially free of dairy ingredients.

41. The frozen confection of claim 36 wherein the level of protein is 0.3wt % or greater.

42. The frozen confection of claim 36 wherein the level of sugar solids is within the range of 28-34 wt %.

43. The frozen confection of claim 36 wherein the level of sugar solids is within the range of 30-34 wt %.

44. The frozen confection according to claim 36 wherein the average bubble diameter is between 20 and 200 um, in the produced ice cream product after hardening to below −18° C.

45. The frozen confection of claim 36 having an overrun of from 100% up to less than 250%.

46. The frozen confection of claim 36 wherein the base confection is essentially free of protein hydrolyzates and the vegetable protein is added in a form essentially free of starch hydrolyzates

47. The frozen confection of claim 36 having an overrun of from 30% up to less than 250%.

48. The frozen confection according to claim 36 wherein between 25 and 100% of the total protein is from one or more vegetable sources selected from the group of pea.

49. A frozen confection comprising:
From 2 to 8 wt % of a saturated oil from the group of coconut, illipe, shea, palm, palm kernel, and sal and mixtures thereof, and
1.5 wt % or less of total protein, wherein between 25 and 100% protein of the total protein is from one or more vegetable sources selected from the group of pea protein, chickpea beans, soy protein, cotton seed protein, sunflower seed, oat protein, lentil protein, sesame seed protein, canola protein, broad bean protein, horse bean protein, alfalfa protein, clover protein, rice protein, tapioca protein, potato protein, carob protein and/or corn protein , the pH of the composition being at least 5, the frozen confection being essentially free of hydrogenated triglyceride fats,

50. A frozen confection comprising:
From 2 to 8 wt % of a saturated oil from the group of coconut, illipe, shea, palm, palm kernel, and sal and mixtures thereof, and
1.5 wt % or less of total protein, wherein between 25 and 100% protein of the total protein is from one or more vegetable sources selected from the group of pea protein, chickpea beans, soy, cotton seed protein, sunflower seed, oat protein, lentil protein, sesame seed protein, canola protein, broad bean protein, horse bean protein, alfalfa protein, clover protein, rice protein, tapioca protein, potato protein, carob protein and/or corn protein , the pH of the composition being at least 5, the frozen confection being essentially free of hydrogenated triglyceride fats wherein the average bubble diameter is between 20 and 200 um, in the produced ice cream product after hardening to below −18° C.
